(19) United States
(12) Patent Application Publication
(10) Pub. No.: US 2025/0155316 A1
(43) Pub. Date: May 15, 2025

(54) LIMITING MEMBER, LIMITING JIG HAVING THE LIMITING MEMBER, AND VIBRATION TESTING DEVICE HAVING THE LIMITING JIG

(71) Applicant: Fulian Precision Electronics (Tianjin) Co., LTD., Tianjin (CN)

(72) Inventor: CHIA-HSIU WU, New Taipei (TW)

(21) Appl. No.: 18/947,150

(22) Filed: Nov. 14, 2024

(30) Foreign Application Priority Data
Nov. 14, 2023 (CN) 202311517815.2

(51) Int. Cl. G01M 7/02; G01M 7/08

(52) U.S. Cl. CPC G01M 7/027; G01M 7/08

(57) ABSTRACT

A limiting member includes a guiding portion, a first limiting portion slidably connected to the guiding portion for contacting a server. A first guide rod is threadedly connected to the guiding portion, with one end abutting against the first limiting portion to push it into contact with the server. There is also a second limiting portion arranged on the first limiting portion and slidably connected to the guiding portion for contacting the server. A second guide rod is threadedly connected to the guiding portion, with one end abutting against the second limiting portion to push it into contact with the server.

### FIELD

The subject matter herein generally relates to the field of vibration testing, and more particularly, to a limiting member, a limiting jig having the limiting member, and a vibration testing device having the limiting jig.

### BACKGROUND

Servers need to undergo shock tests and vibration tests. In related arts, stoppers are typically used to fix the server in the horizontal direction on a platform.

However, gaps may be formed between the stopper and the server during the test, such that the output waveform of the vibrator may be incomplete and exceed the specified range, thereby resulting in test failure.

### BRIEF DESCRIPTION OF THE DRAWINGS

Implementations of the present technology will now be described, by way of example only, with reference to the attached figures, wherein:

FIG. 1 is a diagrammatic view of a vibration testing device in a using state according to one embodiment of the present application.

FIG. 2 is a diagrammatic view of the vibration testing device of FIG. 1 in another using state.

FIG. 3 is a diagrammatic view of a limiting member of the vibration testing device in FIG. 1.

FIG. 4 is an exploded view of the limiting member in FIG. 3.

FIG. 5 is a diagrammatic view of a limiting member and a stacked member according to another embodiment of the present application.

FIG. 6 is an exploded view of a positioning member of the vibration testing device in FIG. 1.

FIG. 7 is a diagram of maximum stresses, maximum train rates, and maximum displacements of a first limiting portion when a server is subjected to different forces.

FIG. 8 is a diagram of maximum stresses, maximum train rates, and maximum displacements of a second limiting portion when the server is subjected to different forces.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

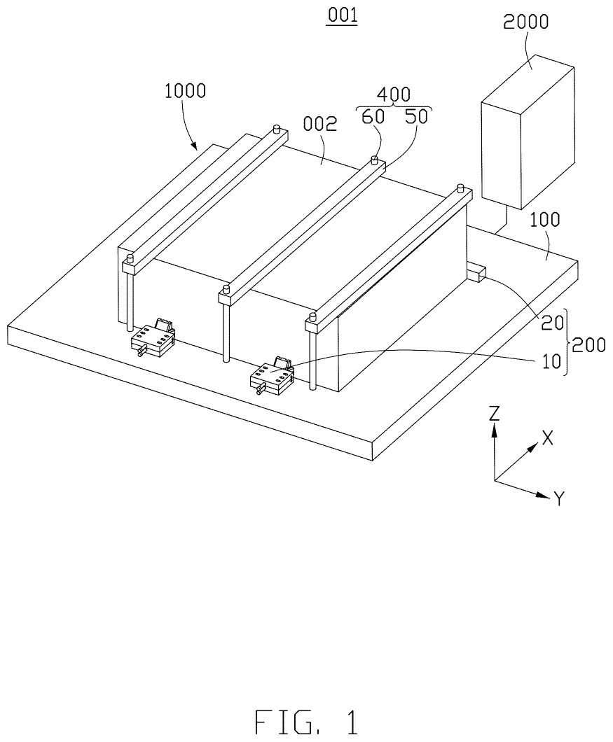

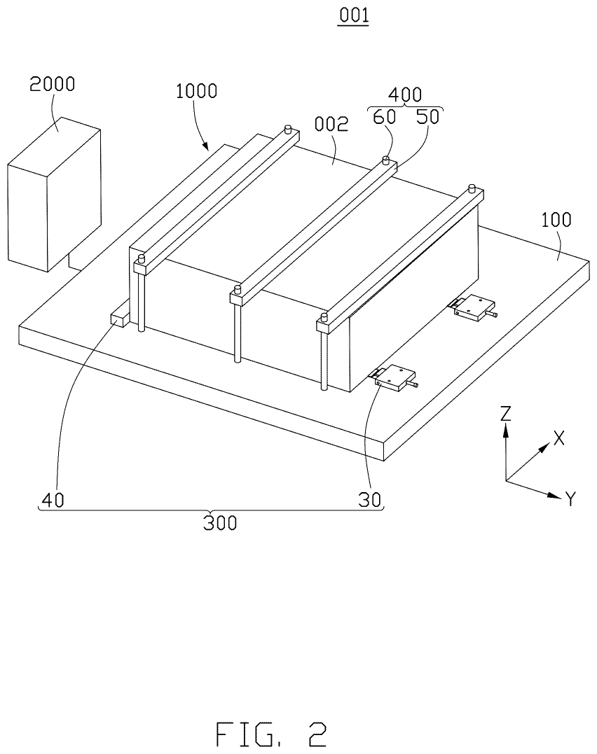

Referring to FIGS. 1 and 2, a vibration testing device 001 is provided according to an embodiment of the present application. The vibration testing device 001 is used for performing vibration and shock tests on a server 002. The vibration testing device 001 includes a limiting jig 1000 and a vibrator 2000. The server 002 is placed on the limiting jig 1000, and the vibrator 2000 is connected to the limiting jig 1000 and drives the limiting jig 1000 to vibrate, thereby performing the vibration and shock tests on the server 002.

The limiting jig 1000 includes a base 100 and a first limiting assembly 200. The first limiting assembly 200 is arranged on the base 100. The vibrator 2000 is connected to the base 100. The server 002 is placed on the base 100, and the first limiting assembly 200 limits the position of the server 002 in a first direction X.

In some embodiments, the limiting jig 1000 further includes a second limiting assembly 300 and a third limiting assembly 400. Both of the second limiting assembly 300 and the third limiting assembly 400 are arranged on the base 100. The second limiting assembly 300 limits the position of the server 002 in a second direction Y, and the third limiting assembly 400 limits the position of the server 002 in a third direction Z. By limiting the server 002 in three different directions, the position of the server 002 is kept stable. The first direction X and the second direction Y are horizontal directions and are perpendicular to each other. The third direction Z is the vertical direction, perpendicular to the horizontal plane formed by the first direction X and the second direction Y.

In some embodiments, when the vibration testing device 001 is used to test the server 002, the vibration testing device 001 does not limit the server 002 in both of the first direction X and the second direction Y simultaneously. For example, through a cooperation of the first limiting assembly 200 and the third limiting assembly 400, the server 002 is limited in the first direction X and the third direction Z, thereby performing the vibration and shock tests on the server 002 in the first direction X, as shown in FIG. 1. Alternatively, through a cooperation of the second limiting assembly 300 and the third limiting assembly 400, the server 002 is limited in the second direction Y and the third direction Z, thereby performing the vibration and shock tests on the server 002 in the second direction Y, as shown in FIG. 2.

The server 002 has a length direction, a width direction, and a height direction. The length direction is parallel to the second direction Y, the width direction is parallel to the first direction X, and the height direction is parallel to the third direction Z. The first limiting assembly 200 abuts against both sides of the server 002 in the length direction, the second limiting assembly 300 abuts against both sides of the server 002 in the width direction, and the third limiting assembly 400 cooperates with the base 100 to abut against both sides of the server 002 in the height direction.

The first limiting assembly 200 includes a limiting member 10 and a first limiting rod 20. Both of the limiting member 10 and the first limiting rod 20 are arranged on the base 100 and spaced from each other along the first direction X. The server 002 is placed between the limiting member 10 and the first limiting rod 20. The limiting member 10 is in contact with one side of the server 002, and the first limiting rod 20 is in contact with another side of the server 002, thereby limiting the position of the server 002 in the first direction X.

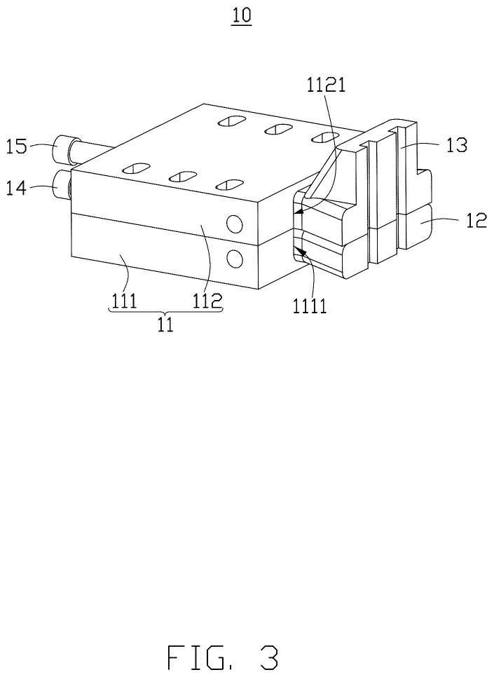

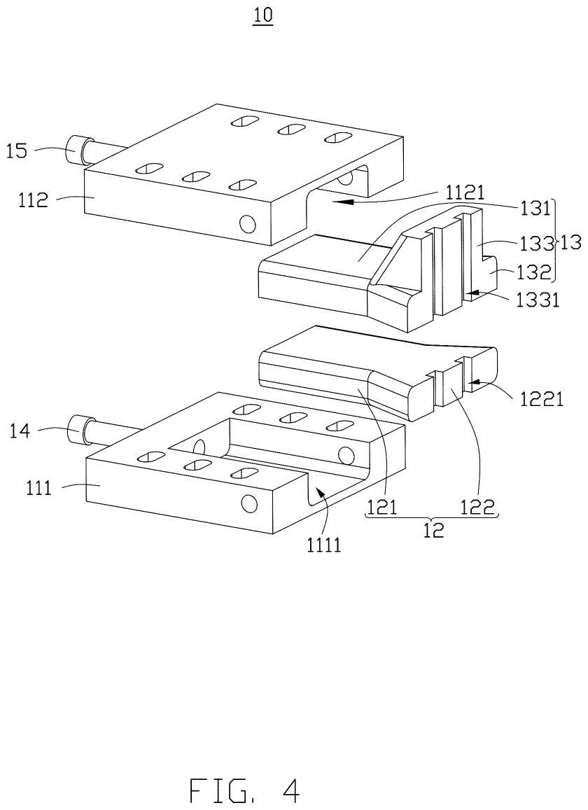

Referring to FIGS. 3 and 4, the limiting member 10 includes a guiding portion 11, a first limiting portion 12, a first guide rod 14, a second limiting portion 13, and a second guide rod 15. The guiding portion 11 is fixed on the base 100. Both of the first limiting portion 12 and the second limiting portion 13 are slidably connected to the guiding portion 11, and the sliding direction of the first limiting portion 12 and the second limiting portion 13 are parallel to the first direction X. Both of the first limiting portion 12 and the second limiting portion 13 are in contact with one side of the server 002. The first guide rod 14 and the second guide rod 15 both extend along the first direction X and are threadedly connected to the guiding portion 11. One end of the first guide rod 14 abuts against the first limiting portion 12 to push the first limiting portion 12 to be in contact with the server 002. Similarly, one end of the second guide rod 15 abuts against the second limiting portion 13 to push the second limiting portion 13 to be in contact with the server 002.

When in use, the server 002 is placed on the base 100 and between the limiting member 10 and the first limiting rod 20. The first guide rod 14 and the second guide rod 15 are sequentially or simultaneously rotated to make the first limiting portion 12 and the second limiting portion 13 to push against the server 002. The first limiting portion 12 and the second limiting portion 13 cooperate with the first limiting rod 20, thereby limiting the position of the server 002 in the first direction X.

By pushing the server 002 sequentially by the first limiting portion 12 and the second limiting portion 13, the number of contact points between the server 002 and the limiting member 10 is increased, thereby enhancing the stability of the server 002 on the base 100. For example, more contact points mean that the server 002 is more firmly connected to the first and second limiting member. When subjected to external forces, such as during a vibration test, these multiple contact points can jointly share and disperse the external forces, thereby restricting the movement of the server 002 in different directions. Thus, displacement during a vibration test, which may lead to gaps between the first limiting portion 12 and the server 002 or between the second limiting portion 13 and the server 002, is avoided. This in turn prevents the vibrator 2000 to output incomplete waveforms that exceed a specified range and ultimately resulting in test failure.

Furthermore, since different types of servers 002 have different heights along the third direction Z, a separatable design of the first limiting portion 12 and the second limiting portion 13 allows the limiting member 10 to adapt to different servers 002. When the height of the server 002 is small, only one of the first limiting portion 12 or the second limiting portion 13 may be used to press against the server 002, thereby ensuring that the height of the limiting member 10 in the third direction Z is always lower than the height of the server 002, and reducing interference between the third limiting assembly 400 and the limiting member 10. Thus, the limiting member 10 provides a more flexible way to limit the server 002 in the first direction X.

In some embodiments, the guiding portion 11 includes a first guiding block 111 and a second guiding block 112 stacked on the first guiding block 111. The first guiding block 111 is disposed on the base 100, and the second guiding block 112 is disposed on the first guiding block 111. The first guiding block 111 defines a first sliding groove 1111. The first sliding groove 1111 penetrates an upper surface (not shown) of the first guiding block 111 and a side surface (not shown) of the first guiding block 111 near the first limiting rod 20. The first limiting portion 12 is slidably connected to the first sliding groove 1111, and the first guide rod 14 is threadedly connected to the first guiding block 111.

The second guiding block 112 defines a second sliding groove 1121. The second sliding groove 1121 penetrates a lower surface (not shown) of the second guiding block 112 and a side surface (not shown) of the second guiding block 112 near the first limiting rod 20. The second limiting portion 13 is slidably connected to the second sliding groove 1121. The second guide rod 15 is threadedly connected to the second guiding block 112.

By using the first sliding groove 1111 to guide the first limiting portion 12 and the second sliding groove 1121 to guide the second limiting portion 13, the first guide rod 14 moves the first limiting portion 12 toward the first limiting rod 20, and the second guide rod 15 moves the second limiting portion 13 toward the first limiting rod 20 with high stability, thereby ensuring that both of the limiting portions may stably press against the server 002.

The first limiting portion 12 is slidably connected to the first sliding groove 1111, and the first sliding groove 1111 does not penetrate a bottom of the first guiding block 111. Therefore, the bottom of the first limiting portion 12 is spaced from the base 100, reducing a contact area of the first limiting portion 12 and the server 002, thereby facilitating the movement of the first limiting portion 12 to abut against the server 002. Additionally, since the base 100 is exposed to the environment and may have impurities or wear, the first limiting portion 12 is not in directly contact with the base 100 and may be fully fitted with the server 002.

Optionally, the first guiding block 111 and the second guiding block 112 have identical shapes to reduce part varieties and facilitate production.

In some embodiments, the base 100 has multiple mounting holes (not shown). Both of the first guiding block 111 and the second guiding block 112 have elliptical through holes (not shown). When installing the first limiting assembly 200 on the base 100, the through holes of the first guiding block 111 and the second guiding block 112 align with the mounting holes on the base 100. A fastener (not shown), such as a bolt, passes through the through hole and the mounting hole to fix the first limiting assembly 200 to the base 100. This design allows for easy installation and adjustment of the first limiting assembly 200, as the elliptical through holes provide some degree of flexibility in positioning. Additionally, the use of a locking fastener ensures a secure connection between the first limiting assembly 200 and the base 100, preventing any unwanted movement or displacement during operation.

Referring to FIG. 4, in some embodiments, the first limiting portion 12 includes a first sliding block 121 and a first pushing block 122. The first sliding block 121 is slidably connected to the first sliding groove 1111 of the first guiding block 111. The first pushing block 122 is connected to the first sliding block 121, and a width of the first pushing block 122 gradually increases away from the first sliding block 121. One side of the first pushing block 122 away from the first sliding block 121 is used to be in contact with the server 002. The width of the first pushing block 122 is parallel to the second direction Y. The gradual increase in the width of the first pushing block 122 enhances a contact area with the server 002, thereby improving stability of the server 002 and first pushing block 122.

Optionally, the first sliding block 121 is rectangular and matches the shape of the first sliding groove 1111, allowing the first sliding block 121 to guide the first sliding block 121. The first pushing block 122 is trapezoidal.

Optionally, along the first direction X, a length of the first sliding block 121 is greater than a length of the first pushing block 122, which provides a larger contact area with the first sliding groove 1111 to guide the first sliding block 121 to move.

In some embodiments, the second limiting portion 13 includes a second sliding block 131 and a second pushing block 132. The second sliding block 131 is slidably connected to the second sliding groove 1121 of the second guiding block 112. A lower surface of the second sliding block 131 is in contact with an upper surface of the first sliding block 121. The second pushing block 132 is connected to the second sliding block 131, and a lower surface of the second pushing block 132 is in contact with an upper surface of the first pushing block 122. A width of the second pushing block 132 gradually increases away from the second sliding block 131. One side of the second pushing block 132 away from the second sliding block 131 is in contact with the server 002. The width direction of the second pushing block 132 is parallel to the first direction X.

In some embodiments, the second limiting portion 13 further includes a reinforcing block 133. The reinforcing block 133 is disposed on the second pushing block 132. One side of the reinforcing block 133 away from the second sliding block 131 is flush with the second pushing block 132.

By providing the reinforcing block 133, the strength of the second limiting portion 13 increases, thereby reducing deformation of the second limiting portion 13. Additionally, the reinforcing block 133 being flush with the second pushing block 132 increases the contact area with the server 002, thereby further enhancing stability of the server 002 on the base 100. Optionally, the reinforcing block 133 is triangular.

In some embodiments, one side of the first pushing block 122 near the first limiting rod 20 defines a first through groove 1221, the first rough groove 1221 is vertically arranged and penetrates an upper and lower surfaces of the first pushing block 122. The second pushing block 132 and the reinforcing block 133 define a second through groove 1331 on the side near the first limiting rod 20, and the second through groove 1331 is also vertically arranged and penetrates an upper and lower surfaces of the second pushing block 132. Along the third direction Z, the first through groove 1221 and the second through groove 1331 are aligned with each other vertically.

Since the server 002 may have a complex structure with various components or protrusions on an outer surface of the server 002, the first through groove 1221 and the second through groove 1331 allow the corresponding components or protrusions to fit therein, thereby increasing the contact area between the limiting portions and the server 002.

In some embodiments, one end of the first sliding block 121 away from the first pushing block 122 defines a positioning hole (not shown) into which the first guide rod 14 extends, thereby ensuring accurate positioning when the first guide rod 14 pushes the first sliding block 121. Similarly, the second sliding block 131 defines a positioning hole (not shown) for the second guide rod 15 to extend.

The first limiting rod 20 extends along the second direction Y to increase the contact area with the server 002. The first limiting rod 20 and the limiting member 10 cooperatively limit the position of the server 002 along the first direction X.

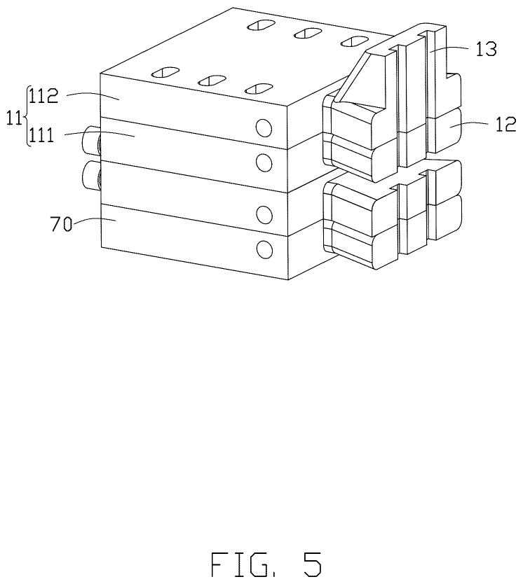

Referring to FIG. 5, in some embodiments, the first limiting assembly 200 further includes a stacked member 70. The stacked member 70 is arranged on the base 100. The limiting member 10 is disposed on the top of the stacked member 70. The stacked member 70 is used to be in contact with the server 002 to increase the contact area between the first limiting assembly 200 and the server 002.

In some embodiments, both of the stacked member 70 and the guiding portion 11 define corresponding connecting holes (not shown), allowing fasteners (e.g., bolts) to pass through and connect the stacked member 70 and the guiding portion 11 to the base 100, thus fixing the stacked member 70 and the limiting member 10.

Different servers 002 may have different heights, but a height of the first limiting assembly 200 in the third direction Z should be less than a height of the server 002. Thus, only the limiting member 10 may be set when the height of the server 002 is small. As the height of the server 002 increases, the number of stacked members 70 may be increased accordingly to enhance the contact area between the server 002 and the stacked members 70.

In some embodiments, multiple stacked members 70 are stacked vertically to further increase the contact area with the server 002. Users can select the appropriate number of stacked members 70 based on the height of the server 002.

The structure of the stacked member 70 is similar to that of the limiting member 10, except that the reinforcing block 133 is omitted from the stacked member 70. Thus, multiple stacked members 70 may be stacked vertically to increase the contact area with the server 002. Since the stacked member 70 and the limiting member 10 have similar structures, the stacked member 70 and the limiting member 10 may be used interchangeably during the test, thereby reducing the number of the components of the limiting jig 1000.

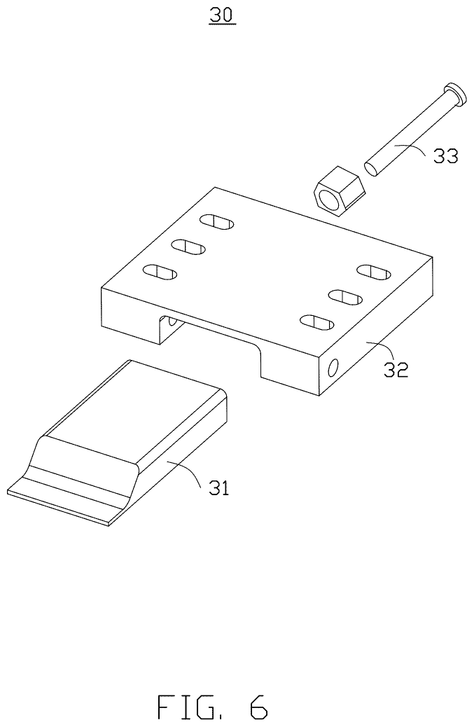

Referring to FIGS. 2 and 6, in some embodiments, the second limiting assembly 300 includes a positioning member 30 and a second limiting rod 40, which are arranged at intervals along the second direction Y to limit the server 002 in the second direction Y.

The positioning member 30 includes a positioning block 31, a guiding block 32, and a push rod 33. The guiding block 32 is set on the base 100, and the positioning block 31 is slidably connected to the guiding block 32. The push rod 33 is threadedly connected to the guiding block 32, and may push the positioning block 31 to be in contact with the server 002.

Optionally, the guiding block 32 has the same structure as the second guiding block 112, and the push rod 33 is similar to the second guide rod 15. That is, the second guiding block 112 can replace the guiding block 32, and the second guiding block 112 and the guiding block 32 can be used interchangeably to limit the server 002 along different directions.

One side of the positioning block 31 facing the second limiting rod 40 decreases in thickness along the third direction Z. The sides of the server 002 along the second direction Y have interfaces and other components, making surfaces of the server 002 uneven. Thus, reducing the thickness of the positioning block 31 allows the positioning block 31 to fit the server 002 better.

In some embodiments, a bottom surface of the positioning block 31 is in contact with the base 100. Thus, the position of the positioning block 31 is low, which allows the positioning block 31 to be in contact with the server 002.

Referring to FIG. 1, in some embodiments, the third limiting assembly 400 includes multiple pressing rods 50 and multiple screw rods 60. The pressing rods 50 are arranged at intervals along the second direction Y, and each pressing rod 50 extends along the first direction X. The pressing rods 50 are arranged above the base 100 and press against an upper surface of the server 002, thereby limiting the position of the server 002 in the third direction Z. Each pressing rod 50 has two corresponding screw rods 60 at opposite ends, and each screw rod 60 extends along the third direction Z. One end of each screw rod 60 connects to the base 100, and the other end connects to the pressing rod 50, thereby pressing the server 002 and limiting the position of the server 002 in the third direction Z.

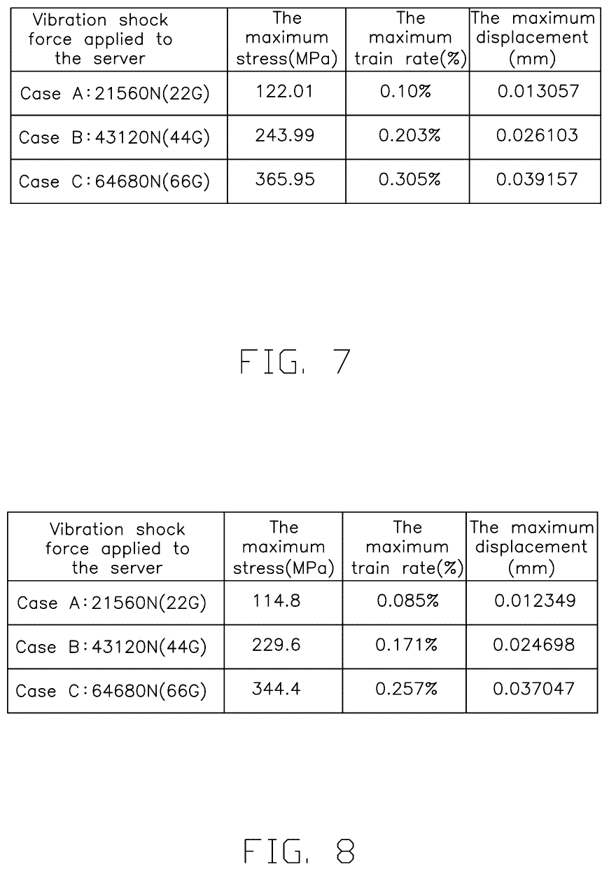

Optionally, refer to FIGS. 7 and 8, both the first limiting portion 12 and the second limiting portion 13 are made of medium carbon steel. As shown in FIG. 7, when the server 002 is subjected to a vibration shock force of 21,560 N, the maximum stress on the contact surface between the first limiting portion 12 and the server 002 is 122.01 MPa, the maximum strain rate is 0.10%, and the maximum displacement is 0.013057 mm. Since the yield strength of medium carbon steel is 365 MPa and the ultimate elongation is 18%, the first limiting portion 12 remains within acceptable limits, and the position of the first limiting portion 12 relative to the base 100 remains stable, thereby keeping the server 002 stable.

Correspondingly, when the server 002 is subjected to a force of 43,120 N, the first limiting portion 12 still maintains good stability. At the force reaches 64,680 N, the maximum stress of the first limiting portion 12 slightly exceeds the yield strength, but in the vibration testing of the server, the force not larger than 21,560 N is typically sufficient.

As shown in FIG. 8, the second limiting portion 13 maintains good stability even when subjected to a force of 64,680 N.

In some embodiments, a vibration test was conducted to determine the vibration frequency of the first limiting portion 12 in the first direction X, the second direction Y, and the third direction Z when the vibrator 2000 drives the base 100 to vibrate along the first direction X. The test result shows: below 1000 Hz, the vibration frequency in the first direction X remains constant, which matches the vibration frequency of the base 100, indicating stability of the first limiting member 10. At 2000 Hz, there is a situation where vibration frequencies of different directions intersect with each other, which indicates a potential resonance risk. Below 2000 Hz, no resonance risk occurs. Since the vibration test is typically performed at a vibration frequency below 500 Hz, the resonance risk that may cause failure in the first limiting portion 12 is minimal.

Moreover, when the vibrator 2000 drives the base 100 to vibrate along the first direction X, the vibration frequencies of the second limiting portion 13 in the first direction X, the second direction Y and the third direction Z are considered. The test result shows: when the vibrate frequency of the base is below 1000 Hz, the resonance risk between the base 100 and the second limiting portion 13 is low, which means the vibration testing device 001 can be used for vibration and shock tests.

In summary, by pushing the server 002 at two positions using the first limiting portion 12 and the second limiting portion 13, the position of the server 002 can be effectively limited, thereby reducing loosening of the server 002 during the vibration of the base 100 and preventing adverse effects on the vibration and shock test.

Even though information and advantages of the present embodiments have been set forth in the foregoing description, together with details of the structures and functions of the present embodiments, the disclosure is illustrative only. Changes may be made in detail, especially in matters of shape, size, and arrangement of portion within the principles of the present exemplary embodiments, to the full extent indicated by the plain meaning of the terms in which the appended claims are expressed.

What is claimed is:

1. A limiting member, comprising:
a guiding portion;
a first limiting portion;
a first guide rod;
a second limiting portion; and
a second guide rod,
wherein the first limiting portion is slidably connected to the guiding portion and configured for contacting a server, the first guide rod is threadedly connected to the guiding portion, one end of the first guide rod abuts against the first limiting portion and configured to push the first limiting portion to be in contact with the server, the second limiting portion is arranged on the first limiting portion, the second limiting portion is slidably connected to the guiding portion and configured for contacting the server, the second guide rod is threadedly connected to the guiding portion, one end of the second guide rod abuts against the second limiting portion and configured to push the second limiting portion to be in contact with the server.

2. The limiting member of claim 1, wherein the guiding portion comprises a first guiding block and a second guiding block, the first guiding block defines a first sliding groove, the first limiting portion is slidably connected to the first sliding groove, the first guide rod is threadedly connected to the first guiding block, the second guiding block is disposed on the first guiding block, the second guiding block defines a second sliding groove communicating with the first sliding groove, the second limiting portion is slidably connected to the second sliding groove, and the second guide rod is threadedly connected to the second guiding block.

3. The limiting member according to claim 1, wherein the first limiting portion comprises a first sliding block and a first pushing block connected to the first sliding block, the first sliding block is slidably connected to the guiding portion, a width of the first sliding block increases in a direction away from the first sliding block, and one side of the first pushing block away from the first sliding block is configured for contacting the server.

4. The limiting member according to claim 3, wherein the side of the first pushing block away from the first sliding block defines a first through groove, and the first through groove penetrates the first pushing block.

5. The limiting member according to claim 3, wherein the one end of the first sliding block away from the first pushing block defines a positioning hole, and the first guide rod extends into the positioning hole.

6. The limiting member according to claim 1, wherein the second limiting portion comprises a second sliding block, a second pushing block, and a reinforcing block, the second pushing block is connected to the second sliding block, the reinforcing block is arranged on the second pushing block, the second sliding block is slidably connected to the guiding portion, a width of the second pushing block increases in a direction away from the second sliding block, one side of the second pushing block away from the second sliding block is configured for contacting the server, and the reinforcing block is flush with the second sliding block.

7. A limiting jig, comprising:
a base; and
a first limiting assembly,
wherein the first limiting assembly comprises a first limiting rod and a limiting member, the first limiting rod and the limiting member are arranged at intervals on the base and configured to limit a position of a server on the base, the limiting member comprising:
a guiding portion;
a first limiting portion;
a first guide rod;
a second limiting portion, and
a second guide rod,
wherein the first limiting portion is slidably connected to the guiding portion for contacting a server, the first guide rod is threadedly connected to the guiding portion, one end of the first guide rod abuts against the first limiting portion to push the first limiting portion into contact with the server, the second limiting portion is arranged on the first limiting portion, the second limiting portion is slidably connected to the guiding portion for contacting the server, the second guide rod is threadedly connected to the guiding portion, one end of the second guide rod abuts against the second limiting portion to push the second limiting portion into contact with the server.

8. The limiting jig of claim 7, wherein the first limiting assembly is configured to limit the server in a first direction, the limiting jig further comprises a second limiting assembly and a third limiting assembly, the second limiting assembly is arranged on the base and configured for limiting the server in a second direction perpendicular to the first direction, the third limiting assembly is arranged on the base and configured for limiting the server in a third direction perpendicular to the first direction and the second direction.

9. The limiting jig of claim 7, wherein the first limiting assembly further comprises a stacked member, the stacked member is arranged on the base, the limiting member is arranged on the stacked member, and the stacked member is configured for contacting the server.

10. The limiting jig of claim 7, wherein the guiding portion comprises a first guiding block and a second guiding block, the first guiding block defines a first sliding groove, the first limiting portion is slidably connected to the first sliding groove, the first guide rod is threadedly connected to the first guiding block, the second guiding block is located above the first guiding block, the second guiding block defines a second sliding groove communicating with the first sliding groove, the second limiting portion is slidably connected with the second sliding groove, the second guide rod is threadedly connected with the second guiding block.

11. The limiting jig of claim 7, wherein the first limiting portion comprises a first sliding block and a first pushing block connected to the first sliding block, the first sliding block is slidably connected to the guiding portion, a width of the first sliding block is increases in a direction away from the first sliding block, one side of the first pushing block away from the first sliding block is configured for contacting the server.

12. The limiting jig of claim 7, wherein the second limiting portion comprises a second sliding block, a second pushing block and a reinforcing block, the second pushing block is connected to the second sliding block, the reinforcing block is arranged on the second pushing block, the second sliding block is slidably connected to the guiding portion, a width of the second pushing block increase in a direction away from the second sliding block, one side of the second pushing block away from the second sliding block is configured for contacting the server, the reinforcing block is flush with the second sliding block.

13. The limiting jig of claim 11, wherein the side of the first pushing block away from the first sliding block defines a first through groove, the first through groove penetrates the first pushing block.

14. The limiting jig of claim 11, wherein the end of the first sliding block away from the first pushing block defines a positioning hole, the first guide rod extends into the positioning hole.

15. A vibration testing device, comprising a vibrator and a limiting jig, the limiting jig comprising:
a base,
and a first limiting assembly,
wherein the first limiting assembly comprises a first limiting rod and a limiting member, the first limiting rod and the limiting member are arranged at intervals on the base to limit the position of a server on the base, the limiting member, comprising:
a guiding portion;
a first limiting portion;
a first guide rod;
a second limiting portion, and
a second guide rod;
wherein the first limiting portion is slidably connected to the guiding portion for contacting a server, the first guide rod is threadedly connected to the guiding portion, one end of the first guide rod is abutted against the first limiting portion to push the first limiting portion into contact with the server, the second limiting portion is arranged on the first limiting portion, the second limiting portion is slidably connected to the guiding portion for contacting the server, the second guide rod is threadedly connected to the guiding portion, one end of the second guide rod is abutted against the second limiting portion to push the second limiting portion into contact with the server, the vibrator is connected to the base of the limiting jig.

16. The vibration testing device 15, wherein the first limiting assembly is configured to limit the server in a first direction, and the limiting jig further comprises a second limiting assembly and a third limiting assembly, the second limiting assembly is arranged on the base for limiting the server in a second direction perpendicular to the first direction, the third limiting assembly is arranged on the base for limiting the server in a third direction perpendicular to the first direction and the second direction.

17. The vibration testing device of claim 15, wherein the first limiting assembly further comprises a stacked member, the stacked member is arranged on the base with the limiting member on top, the stacked member is configured for contacting the server.

18. The vibration testing device of claim 15, wherein the guiding portion comprises a first guiding block and a second guiding block, the first guiding block defines a first sliding groove, the first limiting portion is slidably connected to the first sliding groove, the first guide rod is threadedly connected with the first guiding block, the second guiding block is located above the first guiding block, the second guiding block defines a second sliding groove communicating with the first sliding groove, the second limiting portion is slidably connected with the second sliding groove, the second guide rod being threadedly connected with the second guiding block.

19. The vibration testing device of claim 15, wherein the first limiting portion comprises a first sliding block and a first pushing block connected to the first sliding block, the first sliding block is slidably connected to the guiding portion, a width of the first sliding block increases in a direction away from the first sliding block, one side of the first pushing block away from the first sliding block is configured for contacting the server.

20. The limiting jig of claim 15, wherein the second limiting portion comprises a second sliding block, a second pushing block and a reinforcing block, the second pushing block is connected to the second sliding block, the reinforcing block is arranged on the second pushing block, the second sliding block is slidably connected to the guiding portion, a width of the second pushing block is gradually increasing away from the second sliding block, one side of the second pushing block away from the second sliding block is configured for contacting the server, the reinforcing block is flush with the second sliding block.
